(19) United States
(12) Patent Application Publication
(10) Pub. No.: US 2019/0157698 A1
(43) Pub. Date: May 23, 2019

(54) CORE-SHELL STRUCTURED COMPOSITE POWDER FOR SOLID OXIDE FUEL CELL

(71) Applicant: DAEJOO ELECTRONIC MATERIALS CO., LTD., Siheung-si, Gyeonggi-do (KR)

(72) Inventors: Seung Min Oh, Siheung-si, Gyeonggi-do (KR); Young Ho Lee, Siheung-si, Gyeonggi-do (KR); Chi Ho Yoon, Siheung-si, Gyeonggi-do (KR); Jin Ho Kwak, Siheung-si, Gyeonggi-do (KR); Jang Han Kim, Siheung-si, Gyeonggi-do (KR)

(73) Assignee: DAEJOO ELECTRONIC MATERIALS CO., LTD., Siheung-si, Gyeonggi-do (KR)

(21) Appl. No.: 15/548,457

(22) PCT Filed: Aug. 10, 2016
(86) PCT No.: PCT/KR2016/008813

§ 371 Date: Aug. 3, 2017

(30) Foreign Application Priority Data
Aug. 10, 2016 (KR) 10-2016-0101984
Aug. 10, 2016 (KR) 10-2016-0101985

(51) Int. Cl. H01M 8/1253; H01M 8/126; H01M 4/90

(52) U.S. Cl. CPC H01M 8/1253; H01M 2008/1293; H01M 4/9025; H01M 8/126

(57) ABSTRACT

The present invention relates to a core-shell structured composite powder for a solid oxide fuel cell (SOFC) and more particularly, to a core-shell structured composite powder for a SOFC having a new structure in which nickel, zirconium and yttrium are stably formed in a core shell structure to improve sinterability and conductivity while preventing a fuel electrode from being deformed due to coarsening and contraction of nickel during operation.

### BACKGROUND OF THE INVENTION

### Field of the Invention

The present invention relates to a core-shell structured composite powder for a solid oxide fuel cell (SOFC) and more particularly, to a core-shell structured composite powder for a SOFC having a new structure in which nickel, zirconium and yttrium are stably formed in a core shell structure to improve sinterability and conductivity while preventing a fuel electrode from being deformed due to coarsening and contraction of nickel during operation.

### Discussion of the Related Art

As fossil fuels are gradually depleted, there is a growing demand for new sources of energy. A solid oxide fuel cell, which directly converts chemical energy into electrical energy, has high energy conversion efficiency, may be used as various fuels by its internal reforming, and may improve further efficiency through a hybrid of a gas turbine, thereby attracting attention as a next-generation energy source.

The solid oxide fuel cell uses a high oxygen ion conductivity of an oxide electrolyte and has a structure in which anodes are connected in series, and a cell in which in order to utilize movement of electrons, a spatial separation of hydrogen and oxygen is required, electrons are generated by chemical binding of hydrogen and oxygen and induced to move to another electrodes to generate and use a current. As a material of a fuel electrode, generally, nickel oxide (NiO) and Yttria-stabilized zirconia (YSZ) are used in combination, and as the electrolyte, a material having high thermal stability and ionic conductivity at a high temperature by adding Yttria (Y₂O₃), ceria (CeO₂), scandia (Sc₂O₃), gadolinium oxide (Gd₂O₃), and the like to Zirconia (ZrO₂) or ceria (CeO₂). A unit cell of the solid oxide fuel cell (SOFC) is formed by attaching an air electrode to one side between the solid electrolytes and a fuel electrode to the other side.

As a fuel electrode of the SOFC commonly used at present, yttria-stabilized zirconia (YSZ) stabilized by adding nickel or nickel oxide and yttria is used. Nickel is a good electron conductor in a high-temperature reducing atmosphere and serves as an electron moving path, and the yttria-stabilized zirconia prevents the coarsening of a skeleton and nickel particles that maintain a microstructure and adjusts the thermal expansion coefficient to be similar to that of other constituents, and forms an oxygen ion path, thereby serving as an excellent ion conductor.

Such a fuel electrode in which the nickel oxide and the Yttria-stabilized zirconia are mixed has a merit of simple mixing. However, since the attractive forces between the Yttria-stabilized zirconia and the Yttria-stabilized zirconia, the nickel oxide and the nickel oxide, or the Yttria-stabilized zirconia and the nickel oxide are different from each other, the two powders are not dispersed at the same time in the same dispersion condition and aggregation of powders occurs. In particular, homogeneous agglomeration of relatively large powders in the presence of a difference in size of powders may cause nonuniformity of the microstructure of the fuel electrode. In addition, volume shrinkage of about 30% occurs in the reducing atmosphere heat treatment using nickel oxide and Yttria-stabilized zirconia. As the volume shrinkage occurs, the conductivity of the fuel electrode is lowered due to the decrease in the strength of the fuel electrode and occurrence of cracks, but when nickel (Ni) and Yttria-stabilized zirconia are used, there is an advantage in that the volume shrinkage does not occur and the characteristic deterioration does not occur in the reducing atmosphere.

The nonuniformity of the shape, size, and cohesion of the raw materials constituting the fuel electrode adversely affects the physical properties of the fuel electrode, such as conductivity, fuel permeability, and three-phase interfacial activity, and this degrades the durability, mechanical properties, and an output property of the end cell. In addition, as the grain size and pore size are uneven, densification and coarsening of the Ni occurs, and the coarsening of Ni causes a volume change due to a thermal cycle and an oxidation-reduction reaction, resulting in damage of the electrolyte. In addition, electrochemical activity decreases due to the reduction of the three-phase interface of Ni, YSZ and pores, and the output of the end cell is lowered.

### SUMMARY OF THE INVENTION

An object of the present invention is to provide a flue electrode complex having a new structure of nickel yttria core-shell in order to solve the problem of a fuel electrode in the related art in which nickel oxide and Yttria-stabilized zirconia are mixed.

Another object of the present invention is to provide a preparing method of a fuel electrode having a new structure according to the present invention.

In order to solve the above objects, an exemplary embodiment of the present invention provides a core-shell structured composite powder for a SOFC including:

a core portion composed of at least one of Ni particles or NiO particles; a shell portion formed around the core portion and composed of at least one of yttrium, zirconium, cesium, cerium, scandium, lanthanum, strontium, gallium, magnesium and gadolinium.

In the core-shell structured composite powder for the SOFC, the average diameter of the core portion may be 0.1 to 5.0 μm and the average thickness of the shell portion may be 10 to 500 nm.

In the core-shell structured composite powder for the SOFC, the shell portion may include yttrium and zirconium.

In the core-shell structured composite powder for the SOFC, the core-shell structured composite powder for the SOFC may includes 40 to 80 wt % of nickel, 1 to 10 wt % of yttrium, and 20 to 60 wt % of zirconium.

In the core-shell structured composite powder for the SOFC, a specific surface area may be 1 to 20 m²/g.

In the core-shell structured composite powder for the SOFC, an average particle size (D50) may be 0.2 to 20 um.

Another exemplary embodiment of the present invention provides a preparing method of a core-shell structured composite powder for a SOFC including:
(A) preparing Ni or NiO, a zirconium precursor and a yttrium precursor; and
(B) forming the zirconium precursor and the yttrium precursor on the surface of Ni or NiO using a coprecipitation reaction by adding ammonia water (NH₄OH).

In the preparing method of a core-shell structured composite powder for a SOFC, the zirconium precursor may be zirconium hydroxide (Zr(OH)₄) and the yttrium precursor may be yttrium nitrate (Y(NO₃)₃.6H₂O).

Yet another exemplary embodiment of the present invention provides a preparing method of a core-shell structured composite powder for a SOFC including:
(A) forming a core-shell structure in which Ni or NiO, a zirconium precursor and a yttrium precursor are grown by a yttrium-stabilized zirconium (YSZ) tetragonal crystal on the surface of Ni or NiO through a hydrothermal synthesis reaction; and
(B) drying the hydrothermal synthesized composite powder at a temperature of 100° C. or more in a condition of pH 5 to 8.

According to the core-shell structured composite powder for the SOFC of the present invention, nickel, zirconium and yttrium are stably formed in a core-shell structure, thereby improving sinterability and conductivity while preventing a fuel electrode from being deformed due to coarsening and contraction of nickel during operation at a high temperature.

### BRIEF DESCRIPTION OF THE DRAWINGS

FIG. 1 illustrates an SEM photograph of particles prepared in Examples of the present invention and Comparative Example.

FIG. 2 is a graph obtained by measuring conductivity of the particles prepared in Examples of the present invention by a probing method.

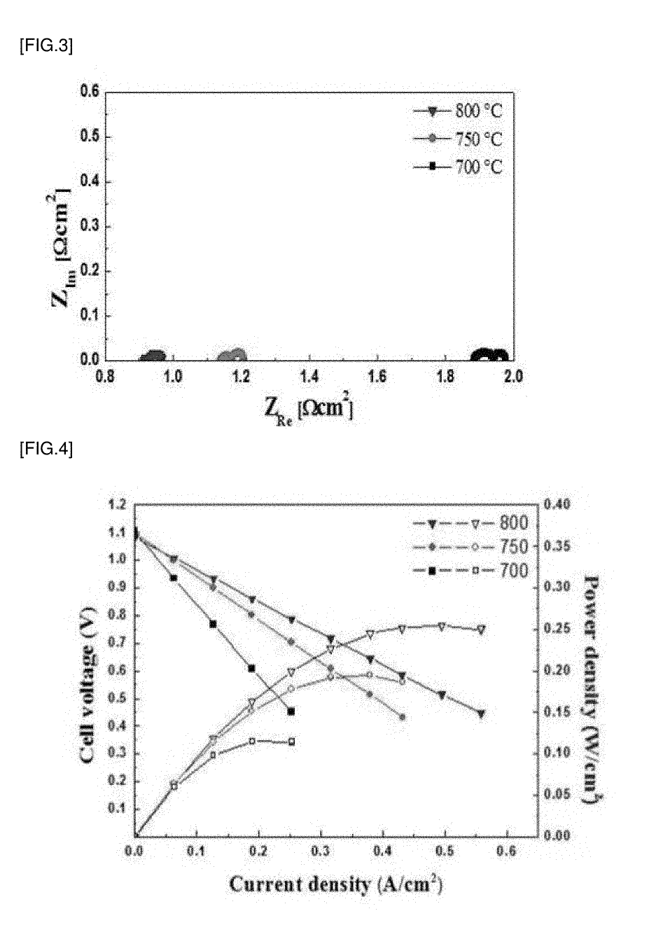

### DETAILED DESCRIPTION OF THE EMBODIMENTS

Hereinafter, the present invention will be described in more detail by Examples. However, the scope of the present invention is not limited to the following Examples.

### Example 1

In Example 1, a micro-sized nickel powder required for the preparation of a core-shell structured powder of nickel/yttria-stabilized zirconia was prepared using liquid reduction.

### Comparative Example 1

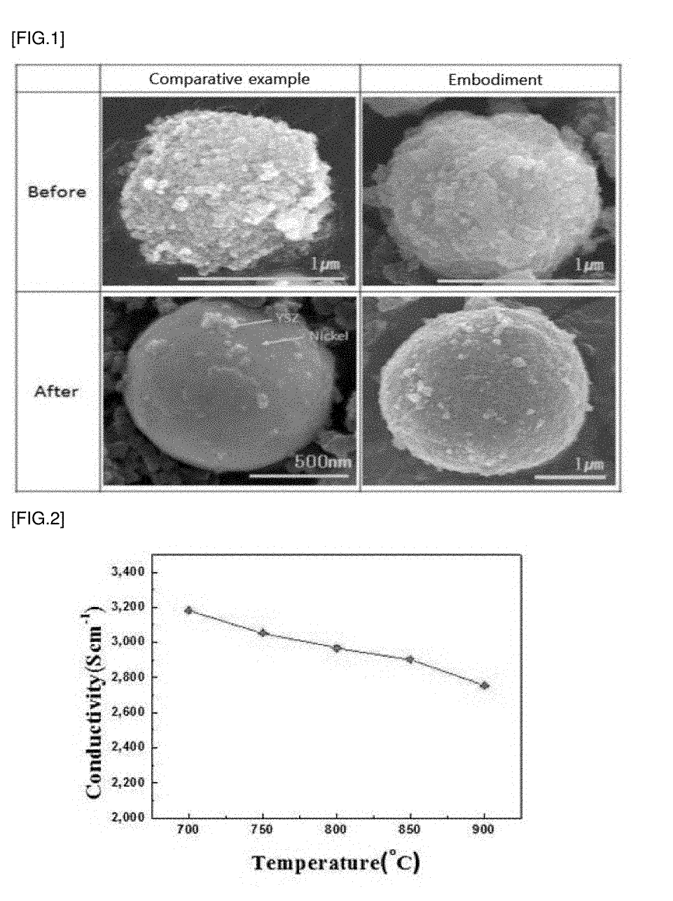

In Comparative Example 1, In order to prepare a core-shell structured powder of nickel/yttria-stabilized zirconia, a core-shell composite structure was prepared as illustrated in FIG. 1 by using and mixing a micro-sized nickel powder and a nano-sized yttria-stabilized zirconia powder at 4000 rpm or more for 30 minutes or more by using a high-speed mixing method.

### Example 2

In Example 2, zirconium oxychloride (ZrOCl₂.8H₂O) and yttrium nitrate (Y(NO₃)₃.6H₂O) were evenly dissolved in distilled water as a starting material of the shell portion and prepared in an aqueous state in order to synthesize the nano-sized yttria-stabilized zirconia powder.

### Example 3

The nano-sized nickel power prepared by the method in the Example 1 was added and continuously stirred in the aqueous solution in which zirconium oxychloride and yttrium nitrate were dissolved in Example 2 by calculating a mass ratio (Nickel:yttria-stabilized zirconia=60 to 80:40 to 50). After confirming that the nickel powder was uniformly dispersed in the aqueous solution, ammonia water was added at a flow rate of 10 to 30 ml/min and subjected to the coprecipitation reaction. It was confirmed that the ammonia water was added, the aqueous solution was opaque and zirconium hydroxide and yttrium hydroxide were mixed uniformly with the nickel powder. When the addition of ammonia water was completed, stirring and filtration were repeated with distilled water until the pH was 8.

### Example 4

In Example 4, the core-shell structured powders of the nickel/yttria stabilized zirconia of Examples 1 to 3 according to the present invention were added into a hydrothermal mixer, and distilled water was added twice as much as the powders and stirred evenly. A hydrothermal synthesizer was maintained at a temperature of 200° C. for 8 hours to allow zirconium hydroxide and yttrium hydroxide to grow into zirconium oxide and yttrium oxide nanocrystals, respectively.

### Example 5

FE-SEM was measured to compare the powder prepared in Example 4 with the powder prepared in Comparative Example 1, and the results are illustrated in FIG. 1 Before.

### Example 6

In Example 6, in order to coat the core-shell powder of nickel/yttria-stabilized zirconia on a fuel electrode for a solid oxide fuel cell, carbon black was mixed and ball-milled to be pasted. In order to observe the surface of the core-shell powder of nickel/yttria-stabilized zirconia, the surface states of the core-shell powder prepared by the present invention after the ball-milling process and the powder prepared by the method of Comparative Example 1 were measured by FE-SEM, and the results were illustrated in FIG. 1 After.

Paste was prepared and a fuel electrode and an air electrode of a 200 um YSZ electrolyte supporter were coated to prepare a measuring cell. The fuel electrode was annealed at 1200° C. in air atmosphere and the air electrode used LSCF and GDC powders.

In the case of the fuel electrode prepared in the present invention, conductivity values of 3054 S/cm² at 750° C. and 2968 S/cm² at 800° C. were shown, and the fuel electrode polarization resistance (ASR) was 0.05 ΩCm² at 800° C. and 0.07 ΩCm² at 750° C., and the results were illustrated in FIGS. 3 and 4.

While hydrogen gas and oxygen were injected into the fuel electrode and the air electrode of the cell prepared for measuring the cell characteristics, an output density was measured by varying the current load in a temperature range of 700, 750, and 800° C. and the results were illustrated in FIG. 4.

What is claimed is:

1. A core-shell structured composite powder for a solid oxide fuel cell (SOFC) comprising:
a core portion composed of at least one of Ni particles or NiO particles; and
a shell portion formed around the core portion and composed of at least one of yttrium, zirconium, cesium, cerium, scandium, lanthanum, strontium, gallium, magnesium and gadolinium.

2. The core-shell structured composite powder for the SOFC of claim 1, wherein the average diameter of the core portion is 0.1 to 5.0 μm and the average thickness of the shell portion is 10 to 500 nm.

3. The core-shell structured composite powder for the SOFC of claim 1, wherein the shell portion may includes yttrium and zirconium.

4. The core-shell structured composite powder for the SOFC of claim 1, wherein the core-shell structured composite powder includes 40 to 80 wt % of nickel, 1 to 10 wt % of yttrium, and 20 to 60 wt % of zirconium.

5. The core-shell structured composite powder for the SOFC of claim 1, wherein a specific surface area is 1 to 20 m²/g.

6. The core-shell structured composite powder for the SOFC of claim 1, wherein an average particle size (D50) is 0.2 to 20 um.
